(19) United States
(12) Patent Application Publication
(10) Pub. No.: US 2004/0177537 A1
(43) Pub. Date: Sep. 16, 2004

(54) Lighting control apparatus

(75) Inventor: Koichiro Nagata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/781,725

(22) Filed: Feb. 20, 2004

(30) Foreign Application Priority Data
Mar. 10, 2003 (JP) 2003-63874

(51) Int. Cl. G02F 1/1335; G09F 1/00

(52) U.S. Cl. 40/465

(57) ABSTRACT

When detecting that a display unit (3) of a vehicle-mounted display device (2) mounted to a vehicle ceiling (1) is placed in a use state 3a, a display unit opening and closing detector 101 sends out a use detection signal. A lighting control circuit (102) limits light emitted out of an indoor lighting device (6) and incident upon the screen of the display unit (3) according to the use detection signal from the display unit opening and closing detector (101).

### BACKGROUND OF THE INVENTION

1. Field of the Invention

The present invention relates to a lighting control apparatus. Particularly, it relates to a lighting control apparatus for controlling a lighting device that can have a detrimental effect on the screen of a display.

2. Description of Related Art

Conventionally, lighting devices for use with a display installed in a moving object, such as a car, for providing light to a display unit of the display device so as to make it easier for users to see the screen of the display unit are proposed. For example, Japanese patent application publication (TOKKAIHEI) No. 8-171079 discloses a lighting device for display provided with a light emitting source (e.g., a backlight) for providing light to a display unit of a display device, and a light emitting source driving circuit for changing the amount of the light emitted out of the light emitting source so as to adjust the luminance of the display unit based on whether or not a voltage for illumination of a moving object is supplied (see paragraph numbers [0001] and [0005] of Japanese patent application publication (TOKKAIHEI) No. 8-171079).

The prior art technology aims to control the amount of light emitted out of a lighting device disposed within a display device, but doesn't aim to control light emitted out of an outside lighting device and incident upon the display device. In other words, the prior art technology doesn't aim to prevent light emitted out of an outside lighting device and incident upon the display device from exerting a detrimental influence upon an image displayed on the screen of the display device.

In general, a moving object, such as a car, ship, or aircraft, has a lighting device for illuminating a room and a lighting device for illuminating an operation unit of a display device. When a user lights one of the lighting devices and operates the operation unit of the display device so as to cause the display device to display a desired image on the screen of the display device, the user can have difficulties in seeing the image due to light emitted out of the lighting device and incident upon the screen of the display device. Therefore, a problem is that when the user has already lit a lighting device for illuminating a room of a moving object, the user has to switch off the lighting device and has to light the lighting device again after the display of images is complete. Another problem is that because a lighting device for illuminating an operation unit of a display device is lit in synchronization with measuring instruments, the user cannot control the lighting device and therefore cannot break a situation in which the user cannot easily see an image displayed on the screen of the display device.

In addition, there is a possibility that light emitted out of a lighting device and reflected from a ceiling or wall is incident upon the screen of a display device other than such a display device mounted in a moving object, e.g., the screen of a display, such as a television intended for home use, a display intended for personal computers, or a projector installed in a conference room or the like, and a situation in which the reflected light causes difficulties in seeing images displayed on the screen of the display device occurs. A further problem is that even in this case, the user needs to operate the lighting device to switch it off or adjust the amount of light and to operate the lighting device to switch on the lighting device again after the display of images is complete.

### SUMMARY OF THE INVENTION

The present invention is proposed to solve the above-mentioned problems, and it is therefore an object of the present invention to provide a lighting control apparatus that prevents light emitted out of a lighting device placed in the vicinity of a display device from being incident upon the screen of the display device when the display device is placed in a use state, thereby preventing users from having difficulties in seeing images displayed on the screen of the display device.

In accordance with the present invention, there is provided a lighting control apparatus including a use detection unit for sending out a use detection signal when detecting that a display unit is placed in a use state, and an optical limitation unit for limiting light emitted out of a lighting unit and incident upon a screen of the display unit according to the use detection signal from the use detection unit. Therefore, the present invention offers an advantage of being able to prevent the light emitted out of the lighting device, which is placed in the vicinity of the display device, from being incident upon the screen of the display device when the display device is placed in the use state, thereby preventing users from having difficulties in seeing images displayed on the screen of the display device.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the structure of a lighting control apparatus in accordance with embodiment 1 of the present invention;

FIG. 2 is a block diagram showing the structure of the lighting control apparatus in accordance with embodiment 1 of the present invention;

FIG. 3 is circuit diagram showing a circuit that constitutes the lighting control apparatus of FIG. 2;

FIG. 4 is a block diagram showing the structure of a lighting control apparatus in accordance with embodiment 2 of the present invention; and

FIG. 5 is circuit diagram showing a circuit that constitutes the lighting control apparatus of FIG. 4.

### DETAILED DESCRIPTION OF THE PREFERRED EMBODIMENTS

The preferred embodiments of the invention will now be described by taking a lighting control apparatus for use with a display disposed in a moving object such as a car, ship, or aircraft as an example, with reference to the accompanying drawings.

### Embodiment 1

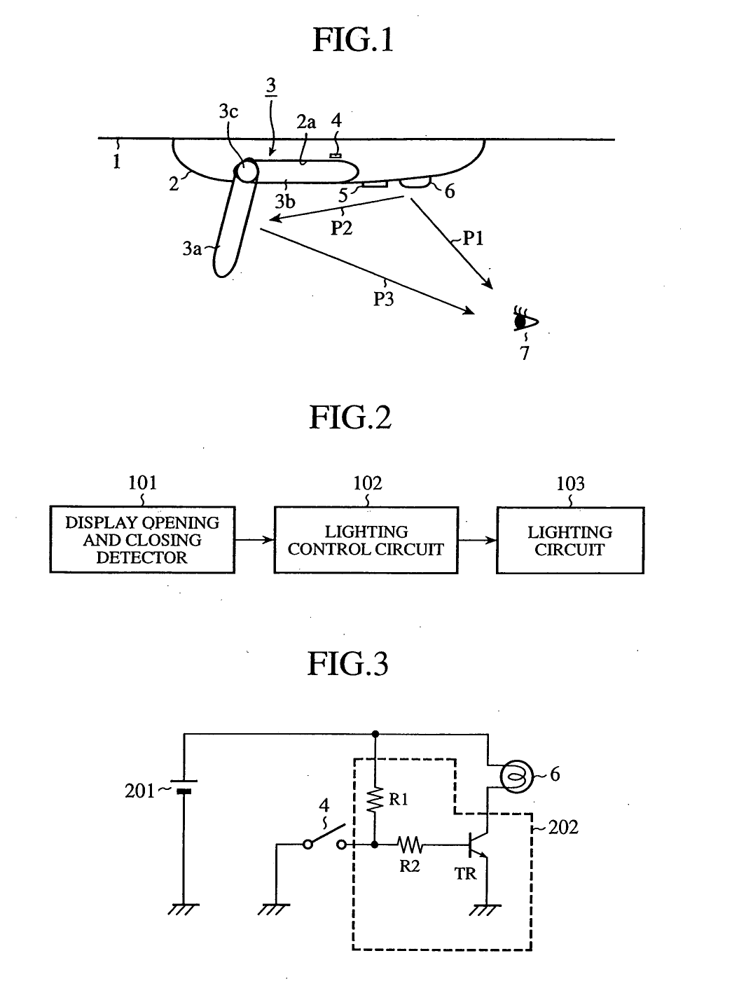

FIG. 1 is a diagram showing the structure of a lighting control apparatus in accordance with embodiment 1 of the present invention. In this figure, a ceiling type vehicle-mounted display device 2 is mounted to a vehicle's ceiling 1. A display unit 3 (i.e., a display means) of the vehicle-mounted display device 2 is so disposed as to pivot about a shaft 3c in such a manner that the display unit 3 is placed at a position designated by reference numeral 3a when the display unit 3 is placed in a use state and is placed at another position designated by reference numeral 3b when the display unit 3 is placed in a disuse state. Hereafter, the use state is designated by reference numeral 3a, and the disuse state is designated by reference numeral 3b. The display unit 3 placed in the disuse state 3b is accommodated in an accommodating recess portion 2a (i.e., an accommodating means) of the vehicle's ceiling 1.

A display opening and closing detection switch 4 (i.e., a use detection means) is disposed in the accommodating recess portion 2a, and the display opening and closing detection switch 4 is brought to an off state by the display unit 3 placed in the disuse state 3b. An opening and closing switch 5 of the vehicle-mounted display device 2 is a switch used for opening or closing the display unit 3. When a user operates this opening and closing switch 5 when the display unit 3 is placed in the disuse state 3b, the shaft 3c is rotated by a driving unit not shown in the figure so that the display unit 3 is brought to the use state 3a. The display opening and closing detection switch 4 is changed to an on state when the display unit 3 is brought to the use state 3a. An indoor lighting device 6 (i.e., a lighting means) disposed within the vehicle is so constructed as to illuminate the opening and closing switch 5 so that the user can operate the vehicle-mounted display device 2 even at nighttime.

When the display unit 3 is brought to the use state 3a, the user can see the screen of the display unit 3 from his or her eye position 7. When the display unit is placed in the use state 3a, if there is no lighting control apparatus in accordance with the present invention, light p1 emitted out of the indoor lighting device 6 disposed within the vehicle directly reaches the user's eye position 7, light p2 is incident upon the screen of the display unit 3, and light p3 reflected from the screen of the display unit 3 also reaches the user's eye position 7. As a result, the user has difficulties in seeing images displayed on the screen of the display unit 3.

In contrast, the lighting control apparatus in accordance with embodiment 1 of the present invention can prevent the user from having difficulties in seeing images displayed on the screen of the display unit 3. FIG. 2 is a block diagram showing the structure of the lighting control apparatus in accordance with embodiment 1 of the present invention. In this figure, an opening and closing detector 101 (i.e., the use detection means) of the display device can detect on/off of the display opening and closing detection switch 4. When the display opening and closing detection switch 4 is placed in an on state and the display unit 3 is placed in the use state 3a, the opening and closing detector 101 sends a use detection signal to a lighting control circuit 102 (i.e., an optical limitation means). The lighting control circuit 102 generates a lighting control signal to limit the amount of the light emitted out of the indoor lighting device 6 according to the use detection signal, and delivers the lighting control signal to the lighting circuit 103.

FIG. 3 is a circuit diagram showing a concrete circuit that constitutes the lighting control apparatus as shown in FIG. 2. In this figure, a vehicle-mounted power supply 201 supplies a predetermined voltage to the indoor lighting device 6. An optical limitation circuit 202 (i.e., the optical limitation means) that is provided with resistors R1 and R2 and a transistor TR corresponds to the lighting control circuit 102 of FIG. 2.

Next, a description will be made as to an operation of the lighting control apparatus in accordance with embodiment 1 of the present invention. When the display unit 3 is accommodated in the accommodating recess portion 2a and is placed in the disuse state 3b, the display opening and closing detection switch 4 is placed in an off state. When the display opening and closing detection switch 4 is placed in the off state, a voltage from the vehicle-mounted power supply 201 is supplied to the base of the transistor TR by way of the resistors R1 and R2 of FIG. 3. Therefore, a circuit between the emitter and collector of the transistor TR becomes an on state, and the indoor lighting device 6 lights up from an electric current supplied thereto from the vehicle-mounted power supply 201.

Then, when the user operates the opening and closing switch 5 so as to move the display unit 3 from the disuse position 3b to the use position 3a, the display opening and closing detection switch 4 is changed from an off state to an on state. When the display opening and closing detection switch 4 enters an on state, the voltage of a junction between the resistors R1 and R2 becomes zero and the voltage of the base of the transistor TR also becomes zero. As a result, the circuit between the emitter and collector of the transistor TR becomes an off state, and therefore the supply of the electric current from the vehicle-mounted power supply 201 is stopped and the indoor lighting device 6 goes out.

As mentioned above, in accordance with this embodiment 1, the lighting control apparatus is provided with the display opening and closing detector 101 for sending out a use detection signal when detecting that the display unit 3 is placed in a use state 3a, and the lighting control circuit 102 for limiting light emitted out of the indoor lighting device 6 and incident upon the screen of the display unit 3 according to the use detection signal from the display opening and closing detector 101. Therefore, the present embodiment offers an advantage of being able to prevent the light emitted out of the indoor lighting device 6 placed in the vicinity of the display device 3 from being incident upon the screen of the display device 3 when the display device 3 is placed in the use state 3a, thereby preventing users from having difficulties in seeing images displayed on the screen of the display device 3.

In addition, because the display opening and closing detector 101 sends out the use detection signal when detecting that the display unit 3 is pulled out from the accommodating recess portion 2a of the vehicle-mounted display device 2, the present embodiment offers an advantage of being able to extremely simplify the structure of the lighting control apparatus.

Instead of using the display opening and closing detection switch 4, the lighting control apparatus can be so constructed as to deliver the use detection signal to the lighting control circuit 102 when detecting that a power supply of the vehicle-mounted display device 2 is switched on. This variant offers an advantage of being able to reduce the cost of the lighting control apparatus because it can use a power supply switch for switching on and off the vehicle-mounted display device 2 as the use detection means.

Instead of causing the indoor lighting device 6 to go off according to the use detection signal, the lighting control apparatus can reduce the light emitted out of the indoor lighting device 6 to such an extent that the lighting control apparatus can prevent users from having difficulties in seeing images displayed on the screen of the display unit. This variant offers an advantage of being able to prevent users from having difficulties in seeing images displayed on the screen of the display unit while maintaining the functionality of the indoor lighting device 6.

### Embodiment 2

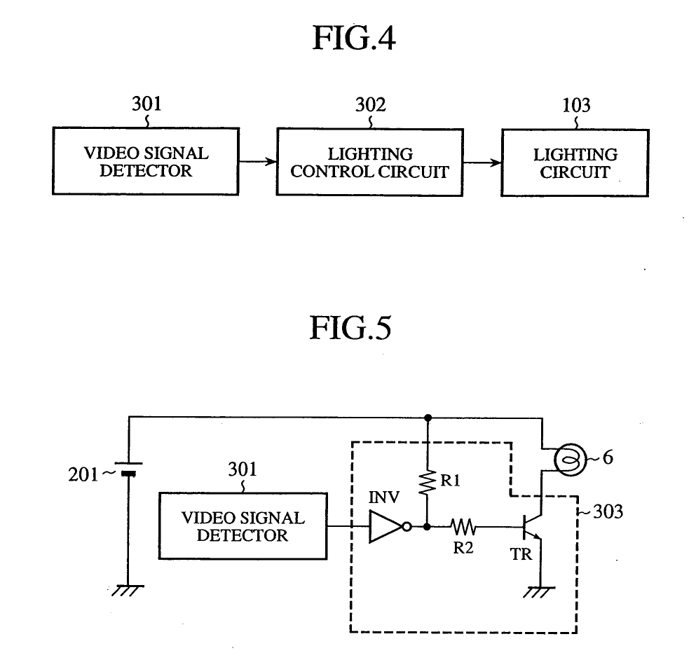

FIG. 4 is a block diagram showing the structure of a lighting control apparatus in accordance with embodiment 2 of the present invention. In this figure, a video signal detector 301 (i.e., a use detection means) for use with a display device can detect an on/off of a video signal input to a display unit 3 of the display device. When the video signal is in an on state and the display unit 3 is placed in a use state, the video signal detector 301 delivers a use detection signal to a lighting control circuit 302 (i.e., an optical limitation means), like the display opening and closing detection unit of the lighting control apparatus in accordance with embodiment 1. The lighting control circuit 302 generates a lighting control signal to limit the amount of light emitted out of an indoor lighting device 6 disposed within a vehicle according to the use detection signal, and delivers the lighting control signal to a lighting circuit 103.

FIG. 5 is a circuit diagram showing a concrete circuit that constitutes the lighting control apparatus as shown in FIG. 4. In this figure, a vehicle-mounted power supply 201 supplies a predetermined voltage to the indoor lighting device 6, like that of the lighting control apparatus of embodiment 1. An optical limitation circuit 303 (i.e., an optical limitation means) that is provided with resistors R1 and R2, a transistor TR, and an inverter circuit INV corresponds to the lighting control circuit 302 of FIG. 4.

Next, a description will be made as to an operation of the lighting control apparatus in accordance with embodiment 2 of the present invention. When detecting no video signal, the display video signal detector 301 supplies a signal at a low level to the inverter circuit INV of the optical limitation circuit 303. In this state, the inverter circuit INV outputs a signal at a high level, and a voltage from the vehicle-mounted power supply 201 is supplied to the base of the transistor TR by way of the resistors R1 and R2 of FIG. 5. Therefore, a circuit between the emitter and collector of the transistor TR becomes an on state, and the indoor lighting device 6 lights up from an electric current supplied thereto from the vehicle-mounted power supply 201.

When detecting a video signal, the video signal detector 301 supplies a use detection signal at a high level to the inverter circuit INV of the optical limitation circuit 303. The inverter circuit INV inverts the use detection signal at a high level to a low level and applies it to a junction between the resistors R1 and R2. In this state, the voltage of the junction between the resistors R1 and R2 becomes zero and the voltage of the base of the transistor TR also becomes zero. As a result, the circuit between the emitter and collector of the transistor TR becomes an of f state, and therefore the supply of the electric current from the vehicle-mounted power supply 201 is stopped and the indoor lighting device 6 goes out.

As mentioned above, in accordance with this embodiment 2, the lighting control apparatus is provided with the video signal detector 301 for sending out a use detection signal when detecting a video signal input to the display unit 3, and the lighting control circuit 303 for limiting light emitted out of the indoor lighting device 6 and incident upon the screen of the display unit 3 according to the use detection signal from the video signal detector 301. Therefore, the present embodiment offers an advantage of being able to prevent the light emitted out of the indoor lighting device 6 placed in the vicinity of the display unit 3 from being incident upon the screen of the display unit 3 when the display unit 3 is placed in a use state in which a vide signal is input, thereby preventing users from having difficulties in seeing images displayed on the screen of the display unit 3.

The structure in accordance with embodiment 2 can be combined with the structure according to above-mentioned embodiment 1. In other words, the lighting control apparatus can be so constructed as to apply a use detection signal to the lighting control circuit 102 (or 302) so as to cause the indoor lighting device 6 to go off when the display unit 3 is displaced from the disuse position 3b to the use position 3a, as shown in FIG. 1, and a video signal is input to the display unit 3.

Instead of causing the indoor lighting device 6 to go off according to the use detection signal, the lighting control apparatus can reduce the light emitted out of the indoor lighting device 6 to such an extent that the lighting control apparatus can prevent users from having difficulties in seeing images displayed on the screen of the display unit. This variant offers an advantage of being able to prevent users from having difficulties in seeing images displayed on the screen of the display unit while maintaining the functionality of the indoor lighting device 6.

### Embodiment 3

In accordance with above-mentioned embodiment 1, above-mentioned embodiment 2, and variants of those embodiments, the lighting control apparatus is so constructed as to limit light emitted out of an indoor lighting device 6 (i.e., cause the indoor lighting device to go off or reduce the amount of the light) when the display unit 3 is placed in a use state. In contrast, a lighting control apparatus in accordance with embodiment 3 is so constructed as to prevent the light emitted out of the indoor lighting device 6 from being incident upon the screen of a display unit 3 by using another mechanism when the display unit 3 is placed in the use state.

For example, the lighting control apparatus can include a movable light shielding plate disposed between the indoor lighting device 6 and the display unit 3, and a mechanism for moving the movable light shielding plate according to a use detection signal so as to prevent the light emitted out of the indoor lighting device 6 from being incident upon the screen of the display unit 3 by using the light shielding plate when the display unit 3 is placed in the use state.

As an alternative, the lighting control apparatus can have a mechanism for moving a movable reflecting plate according to the use detection signal and then changing an optical path of the light emitted out of the indoor lighting device 6 so as to prevent the light emitted out of the indoor lighting device 6 from being incident upon the screen of the display unit 3 when the display unit 3 is placed in the use state.

As previously mentioned, the lighting control apparatus in accordance with each of above-mentioned embodiments aims to control a lighting device for use with a display device installed in a moving object such as a car, ship, or an aircraft. However, the range of applications of the lighting control apparatus in accordance with the present invention is not limited to display devices that can be mounted in a moving object. In other words, the lighting control apparatus in accordance with the present invention can be applied to cases where light emitted out of a lighting device mounted to a ceiling or wall is incident upon a display device, such as a television intended for home use, a display intended for personal computers, or a projector installed in a conference room or the like, and a situation in which light reflected from the screen causes difficulties in seeing images displayed on the screen of the display device occurs.

Many widely different embodiments of the present invention may be constructed without departing from the spirit and scope of the present invention. It should be understood that the present invention is not limited to the specific embodiments described in the specification, except as defined in the appended claims.

What is claimed is:

1. A lighting control apparatus comprising:
a use detection means for sending out a use detection signal when detecting that a display means is placed in a use state; and
an optical limitation means for limiting light emitted out of a lighting means and incident upon a screen of said display means according to said use detection signal from said use detection means.

2. The lighting control apparatus according to claim 1, wherein when detecting that said display means is pulled out from an accommodating means, said use detection means sends out the use detection signal.

3. The lighting control apparatus according to claim 1, wherein when detecting that said display means is powered on, said use detection means sends out the use detection signal.

4. The lighting control apparatus according to claim 1, wherein when detecting a video signal from said display means, said use detection means sends out the use detection signal.

5. The lighting control apparatus according to claim 1, wherein said optical limitation means reduces the light emitted out of said lighting means according to the use detection signal.

6. The lighting control apparatus according to claim 1, wherein said optical limitation means reduces the light incident upon said display means according to the use detection signal.

7. The lighting control apparatus according to claim 1, wherein said optical limitation means changes an optical path of the light incident upon said display means according to the use detection signal.

8. The lighting control apparatus according to claim 1, wherein said optical limitation means limits light that is reflected from the screen of said display means disposed in a moving object and is then incident upon the screen of said display means.
